(19) United States
(12) Patent Application Publication
(10) Pub. No.: US 2008/0138767 A1
(43) Pub. Date: Jun. 12, 2008

(54) Method and system for improving dental esthetics

(76) Inventors: Eric Kuo, Foster City, CA (US); Robert E. Tricca, Danville, CA (US)

Correspondence Address: ALIGN TECHNOLOGY C/O WAGNER BLECHER LLP, 123 WESTRIDGE DRIVE, WATSONVILLE, CA, 95076, US

(21) Appl. No.: 11/635,920

(22) Filed: Dec. 7, 2006

(51) Int. Cl. A61C 13/00

(52) U.S. Cl. 433/167; 433/215

(57) ABSTRACT

A method and system for improving dental esthetics. Specifically, the method includes providing a polymeric shell dental appliance of a type that is removably placeable over a patient's dentition. The polymeric shell dental appliance comprises a concave trough which conforms to at least one tooth when placed over the patient's dentition. In addition, the method includes changing a visual appearance of a segment of the polymeric shell dental appliance. The visual appearance of the segment is changed by applying a thin film to a surface of the segment. In particular, the segment is disposed in a location corresponding to a portion of the patient's dentition that is to be esthetically improved.

### CROSS REFERENCE TO RELATED APPLICATIONS

The planning and fabrication of dental aligners, such as an exemplary elastic polymeric positioning appliance, is described in detail in U.S. Pat. No. 5,975,893, and in published PCT application WO 98/58596 which designates the United States, both entitled “METHOD AND SYSTEM FOR INCREMENTALLY MOVING TEETH,” both of which are assigned to the assignee of the present application.

### BACKGROUND OF THE INVENTION

1. Field of the Invention

Embodiments of the present invention relate in general to orthodontics. More particularly, embodiments of the present invention relate generally to improving dental esthetics when wearing orthodontic appliances.

2. Related Art

Orthodontic treatments involve repositioning misaligned teeth and improving bite configurations for improved cosmetic appearance and dental function. Repositioning is accomplished by applying gentle controlled forces to a patient's teeth over an extended period of time. Due to the limited space within the oral cavity and extensive movements that some teeth must undergo, the teeth will often be moved throughout a series of intermediate patterns to properly arrange the teeth. For example, molars may be temporarily moved backwards (distalized) to create adequate space for movement of the incisors. Thus, a single patient may experience an average of 25-30 stages or alignment patterns before achieving the final desired teeth arrangement.

Conventionally, repositioning of teeth has been accomplished by what are commonly referred to as “braces.” Braces comprise a variety of appliances such as brackets, bands, archwires, ligatures, and O-rings. After they are bonded to the teeth, periodic meetings with the orthodontist are required to adjust the braces. This involves installing different archwires having different force-inducing properties, or replacing or tightening existing ligatures. Between the periodic meetings with the orthodontist, the patient may be required to wear supplementary appliances, such as elastic bands or headgear, to supply additional or extraoral forces. Although conventional braces are effective, their use is often a tedious and time consuming process and requires many visits to the orthodontist's office. Moreover, from the patient's perspective, the use of braces is unsightly, uncomfortable, presents a risk of infection, and makes brushing, flossing, and other dental hygiene procedures difficult. Additionally, as conventional braces are fixedly bonded to the patient's teeth, the braces cannot be removed when the patient is eating.

An alternative to braces includes the use of elastic positioning appliances for realigning teeth. Such an appliance may be comprised of a thin shell of elastic material that generally conforms to a patient's teeth but is slightly out of alignment with the initial tooth configuration. Placement of the elastic positioning appliances over the teeth applies controlled forces in specific locations to gradually move the teeth into a new configuration. Repetition of this process with successive appliances comprising new configurations eventually moves the teeth through a series of intermediate arrangements to a final desired arrangement.

In some cases, wear of the elastic positioning appliances by a patient is unnoticeable. That is, because the elastic positioning appliances may be somewhat translucent, it appears that the patient is not wearing any corrective devices. However, because of this translucent characteristic, any unsightly abnormalities in the patient's teeth will remain visible. For example, a patient's tooth may be missing, either through natural or accidental causes, or by the extraction of one or more teeth for the purposes of repositioning teeth. Also, other unsightly abnormalities includes decaying teeth, broken teeth, or diseased gingiva. In each of these cases, any abnormality would be readily apparent even when wearing the elastic positioning appliances.

One attempt to correct for unsightly abnormalities is the use of pontics. In the conventional art, when correcting for missing teeth, a fake tooth (e.g., pontic) may be built into the elastic positioning appliances to give the appearance of a real tooth when wearing the appliance. Typically, dental professionals are trained in the fabrication of the pontic and incorporation of the pontic into the elastic positioning appliance. A variety of materials and techniques known in the art can be used to fabricate dental pontics. The most commonly employed materials include tooth-shaded dental composites typically used to repair carious lesions, or to fabricate provisional (temporary) crowns and bridges. These materials consist mainly of a polymer matrix and dispersed reinforcing inorganic filler particles that include light, self, dual, vacuum, heat, and pressure curable compositions, or any combination thereof.

Although dental composites have been used to fabricate dental pontics, there are several disadvantages to using these materials. First, the ability of these materials to bond to the thermoplastic of the elastic positioning appliances is poor. That is, the pontic may fall out of the pontic during use by the patient. Second, the polymer matrix used to form the pontic is stiff and non-flexing. As such, retention of the pontic in the elastic positioning appliance is further compromised especially if the appliance is subjected to torsional or flexing forces, such as when the appliance is either being inserted or removed from a patient's mouth, or during vigorous cleaning of the appliance.

Additionally, the formation of pontics requires an involved amount of time and expertise from a dental professional. For example, incorporation of the pontic into the elastic positioning appliance includes shaping, trimming, and forming of the pontic so that it fits within the elastic positioning appliance, and fits within the gap left by the missing tooth, in the above example. This requires the expert use of conventional shaping tools, such as spatulas, knives abrasive material, etc to shape the pontic. Also, during the formation of the pontic, the polymer matrix as the pontic may be cured. For example, the polymer matrix may be visible light cured, self-cured, dual cured, and vacuum, heat, and pressure cured. Each of these processes is performed by a dental professional. As such, the amount of time required by the dental professional is substantial, thereby increasing the overall cost to the patient.

### SUMMARY OF THE INVENTION

Accordingly, various embodiments of the present invention disclose methods and systems for improving dental esthetics. Specifically, the method includes providing a polymeric shell dental appliance of a type that is removably placeable over a patient's dentition. The polymeric shell dental appliance comprises a concave trough which conforms to at least one tooth when placed over the patient's dentition. In addition, the method includes changing a visual appearance of a segment of the polymeric shell dental appliance. The visual appearance of the segment is changed by applying a thin film to a surface of the segment. In particular, the segment is disposed in a location corresponding to a portion of the patient's dentition that is to be esthetically improved.

In addition, in another embodiment, a method for packaging a dental appliance for improving dental esthetics is disclosed. The method comprises providing a bio-compatible paint in a container. The container is breakable for providing access to the bio-compatible paint. The bio-compatible paint is applied in a thin film to a surface of a segment of a dental appliance, wherein the segment is intended for cosmetic change. In addition, the present embodiment further comprises providing an applicator brush for applying the bio-compatible paint to the surface of the segment. Also, the present embodiment encloses the container and the applicator brush in a sterile package.

### BRIEF DESCRIPTION OF THE DRAWINGS

FIG. 1 is an elevational diagram showing the anatomical relationship of the jaws of a patient upon which teeth may be moved by the method and apparatus of embodiments of the present invention.

FIG. 2A illustrates in more detail the patient's lower jaw of FIG. 1 and provides a general indication of how teeth may be moved by the method and apparatus of embodiments of the present invention.

FIG. 2B illustrates the jaw of FIG. 1 together with an incremental position adjustment aligner which has been configured according to the methods and apparatus of embodiments of the present invention.

FIG. 3 is a flow chart illustrating steps in a method for improving dental esthetics through the application of a thin film to a polymeric shell dental appliance, in accordance with one embodiment of the present invention.

FIG. 4 is a diagram illustrating a lower jaw including a gap between teeth together with a polymeric shell dental appliance that has been cosmetically changed to improve the dental esthetics of the gap of the lower jaw, in accordance with one embodiment of the present invention.

FIG. 5 is a flow chart illustrating steps in method for improving dental esthetics through the application of a thin film of bio-compatible paint to a polymeric shell dental appliance, in accordance with one embodiment of the present invention.

FIGS. 6A-6G provide cross sectional views of the polymeric shell polymeric shell dental appliance 410 of FIG. 4 in a location which corresponds to a portion of the patient's dentition that is to be esthetically improved, in accordance with embodiments of the present invention.

FIG. 7 is a flow chart illustrating steps in a method for esthetically improving a patient's dentition through the attaching of a polymeric shell dental appliance that has been cosmetically changed, in accordance with one embodiment of the present invention.

FIG. 8A is a diagram illustrating the wearing of a polymeric shell dental appliance and the gap between teeth that is visible through the polymeric shell dental appliance, in accordance with one embodiment of the present invention.

FIG. 8B is a diagram illustrating the wearing of a polymeric shell dental appliance and the cosmetic change of the polymeric shell dental appliance in a location corresponding to the gap between teeth of a patient that is to be esthetically improved, in accordance with one embodiment of the present invention.

FIG. 9 is a diagram of a packaging system containing a single dose of bio-compatible paint for application on a polymeric shell dental appliance in a location corresponding to a portion of a patient's dentition that is to be esthetically improved.

### DETAILED DESCRIPTION OF THE INVENTION

Reference will now be made in detail to the preferred embodiments of the present invention, methods and systems for attaching thin films to polymeric shell dental appliances for improving dental esthetics, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

Accordingly, various embodiments of the present invention disclose the application of thin films to polymeric shell dental appliances in a location corresponding to a position of a patient's dentition intended for esthetic improvement. As a result, embodiments of the present invention provide the above accomplishment, and further provide for excellent bonding of the thin film to the polymeric shell dental appliance, thereby improving the integrity of the modification to the polymeric shell dental appliance intended to improve dental esthetics of a patient's dentition. Moreover, embodiments of the present invention provide the above accomplishments and further provide for less involvement of a dental professional when providing the improvement of dental esthetics, and therefore a reduction in the overall cost of the use of polymeric shell dental appliances.

### System and Method for Positioning Teeth

Orthodontic treatments involve repositioning misaligned teeth and improving bite configurations for improved cosmetic appearance and dental function. Repositioning is accomplished by applying gentle controlled forces to a patient's teeth over an extended period of time. Due to the limited space within the oral cavity and extensive movements that some teeth must undergo, the teeth will often be moved throughout a series of intermediate patterns to properly arrange the teeth. For example, molars may be temporarily moved backwards (distalized) to create adequate space for movement of the incisors. Thus, a single patient may experience an average of 25-30 stages or alignment patterns before achieving the final desired teeth arrangement.

Conventionally, repositioning of teeth has been accomplished by what are commonly referred to as “braces.” Braces comprise a variety of appliances such as brackets, bands, archwires, ligatures, and 0-rings. After they are bonded to the teeth, periodic meetings with the orthodontist are required to adjust the braces. This involves installing different archwires having different force-inducing properties or by replacing or tightening existing ligatures. Between meetings, the patient may be required to wear supplementary appliances, such as elastic bands or headgear, to supply additional or extraoral forces. Although conventional braces are effective, their use is often a tedious and time consuming process and requires many visits to the orthodontist's office. Moreover, from the patient's perspective, the use of braces is unsightly, uncomfortable, presents a risk of infection, and makes brushing, flossing, arid other dental hygiene procedures difficult.

In embodiments of the present invention, repositioning of teeth may be accomplished with the use of a series of removable elastic positioning appliances, referred to as “aligners”. Such appliances comprise a thin shell of elastic polymeric material that generally conforms to a patient's teeth but is slightly out of alignment with an initial or immediately prior tooth configuration. Placement of the elastic aligner over the teeth applies controlled forces in specific locations to gradually move the teeth into the new configuration. Repetition of this process with successive aligners, comprising new configurations, eventually moves the teeth through a series of intermediate arrangements to a final desired arrangement. Conveniently and advantageously, the appliances are not affixed and the patient may place and replace the appliances at any time during the alignment process.

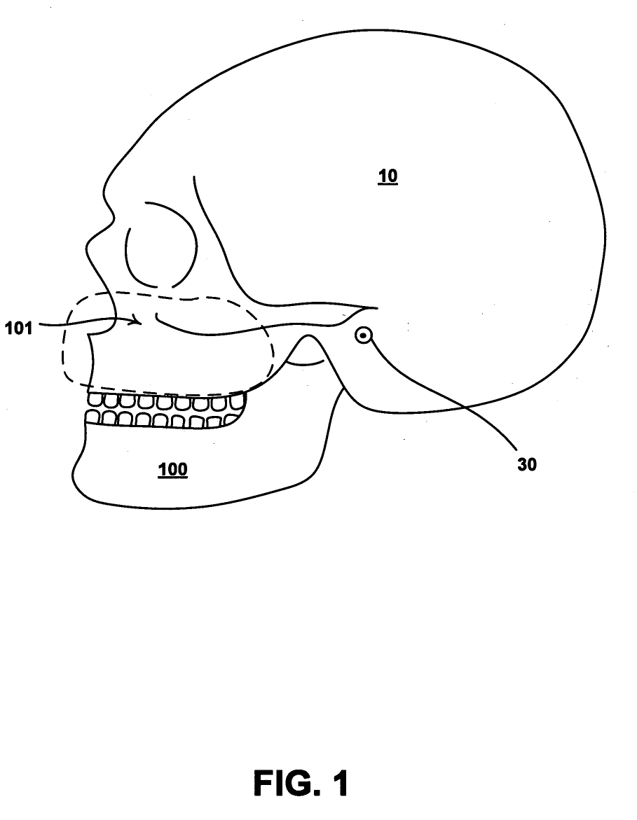

FIG. 1 is an illustration of a skull 10, upon which the repositioning of teeth is accomplished with a series of removable aligners, in accordance with one embodiment of the present invention. The skull 10 includes a maxilla or upper jaw 101 outlined approximately by the dotted circle. A set of upper teeth is associated with the upper jaw 101. The skull 10 also includes a mandible or lower jaw 100. A set of lower teeth is associated with lower jaw 100. Lower jaw 100 hinges at a joint 30 to skull 10. Joint 30 is called a temporomandibular joint (TMJ).

In one embodiment, a computer model of jaws 100 and 101 is generated. A computer simulation is capable of modeling interactions among the teeth on jaws 100 and 101. The computer simulation allows the system to focus on motions involving contacts between teeth mounted on the jaws. The computer simulation allows the system to render realistic jaw movements which are physically correct when jaws 100 and 101 contact each other. The modeling of jaws 100 and 101 places the individual teeth in a treated position.

Further, the model can be used to simulate jaw movements including protrusive motions, lateral motions, and “tooth guided” motions where the path of lower jaw 100 is guided by teeth contacts rather than by anatomical limits of jaws 100 and 101. Motions are applied to one jaw, but may also be applied to both jaws. Based on the occlusion determination, the final arrangement of the teeth in jaws 100 and 101 can be ascertained.

As a result, an initial digital data set (IDDS) representing an initial tooth arrangement and a final digital data set (FDDS) representing a final tooth arrangement are generated. Based on both the IDDS and the FDDS, a plurality of intermediate digital data sets (INTDDSs) are defined to correspond to incrementally adjusted aligners. The INTDDSs are defined using techniques for aligning teeth (e.g., the standard arch method, et c.). Thereafter, a set of incremental position adjustment aligners are produced based on the INTDDs and the FDDS. The aligners are designed to be worn over the teeth and to reposition the teeth to each of the tooth arrangements.

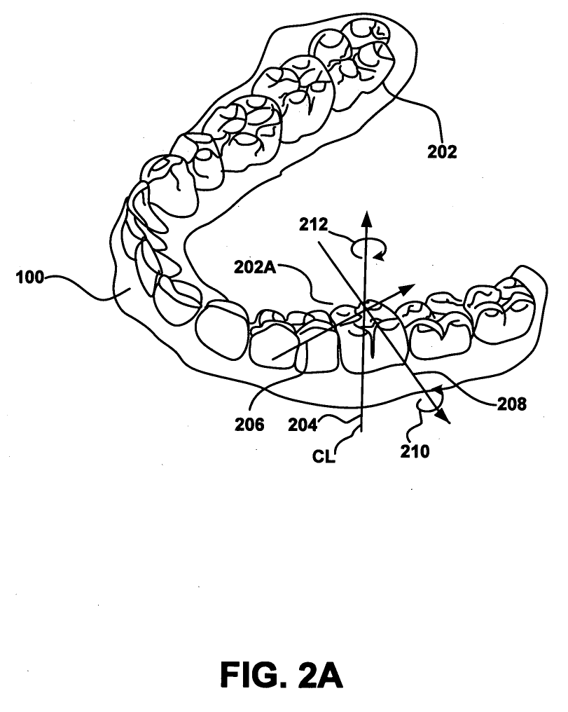

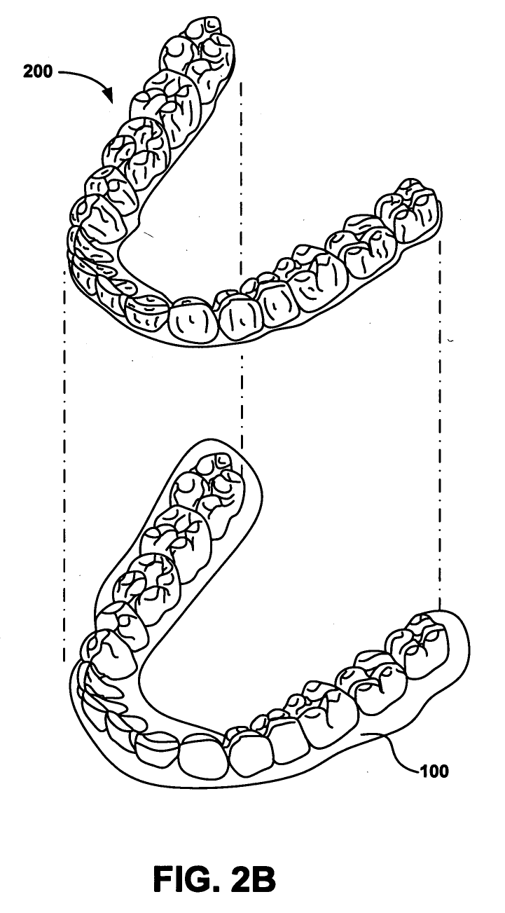

Referring now to FIG. 2A, lower jaw 100 of FIG. 1 includes a plurality of teeth, typically shown as 202, for example, and is provided as an illustration of the repositioning of teeth through the use of an aligner, in accordance with one embodiment of the present invention. The lower jaw 100 of FIG. 2A includes sixteen teeth in the plurality of teeth 202, to include exemplary tooth 202A. Embodiments of the present invention are capable of moving at least some of the plurality of teeth 202 from an initial tooth arrangement to a final tooth arrangement through a series of alignment stages.

In FIG. 2A, an arbitrary frame of reference is shown, and is used to describe how teeth in lower jaw 100 may be moved. For example, the frame of reference can be used to describe how tooth 202A is moved. An arbitrary centerline (CL) is drawn through exemplary tooth 202A. With reference to this centerline, the associated tooth may be moved in the orthogonal directions represented by axes 204, 206, and 208. As shown in FIG. 2A, axis 206 illustrates movement of tooth 202A between the anterior and posterior portions of lower jaw 100. Axis 210 illustrates side to side movement of tooth 202A in lower jaw 100. Axis 212 illustrates the upward and downward movements of tooth 202A in relation to lower jaw 100. In the configuration of FIG. 2A, the centerline corresponds to axis 204.

Additionally, the centerline may be rotated about the axis 208 (root angulation) and 204 (torque) as indicated by arrows 210 and 212, respectively. Also, the exemplary tooth 202A may be rotated about the axis 206. Thus, all possible free-form motions of tooth 202A can be performed.

A patient generally uses a repositioning aligner, corresponding to a given alignment stage in a treatment plan, until the aligner is no longer applying sufficient repositioning forces to the patient's teeth. When a patient first places an aligner over their teeth, the misalignment of the aligner with the teeth will apply forces on the teeth at the points of contact. The larger the misalignment, the stronger the repositioning force.

As the teeth gradually move into a desired arrangement for a given alignment stage and with the continued use of a corresponding aligner, the misalignment between the teeth and the aligner decreases and the applied force lessens until equilibrium is reached. When the teeth substantially reach the desired configuration associated with the corresponding aligner, the force may approach zero. It is at this point that the useful life of such an aligner for applying repositioning force has ended. The patient may then progress to the next alignment stage in the treatment plan and begin wearing the next successive elastic repositioning aligner. The new aligner will apply repositioning forces to move the teeth to the next desired arrangement corresponding to the next alignment stage, repeating the aligner wear cycle.

In summary, the first aligner of a series of aligners will have a geometry selected to reposition a patient's teeth from the initial teeth arrangement to a first intermediate arrangement. After the first intermediate arrangement is approached or achieved, one or more additional, intermediate aligners will be successively placed on the teeth, where such additional aligners have geometries selected to progressively reposition teeth from the first intermediate arrangement through successive intermediate arrangement(s). The treatment will be finished by placing a final aligner in the patient's mouth, where the final aligner has a geometry selected to progressively reposition teeth from the last intermediate arrangement to the final tooth arrangement.

Referring now to FIG. 2B, a single adjustment aligner 200 which is worn by the patient in order to achieve an incremental repositioning of individual teeth in lower jaw 100 of FIG. 1 is shown, in accordance with one embodiment of the present invention. The aligner 200 is one of a series of incremental position adjustment aligners worn by the patient to realign teeth from an initial arrangement to a final arrangement. For brevity and clarity, exemplary aligner 200 is shown for incremental repositioning of teeth in lower jaw 100; however, other embodiments are well suited to the use of aligners for repositioning of teeth in either or both the upper and lower jaws of a patient.

The exemplary aligner 200 comprises a polymeric shell having a cavity shaped to receive and resiliently reposition teeth from one tooth arrangement to a successive tooth arrangement. The polymeric shell will preferably, but not necessarily, fit over all teeth present in the upper or lower jaw (e.g., lower jaw 100). Often, only certain one(s) of the teeth will be repositioned while others of the teeth will provide a base or anchor region for holding the repositioning appliance in place as it applies the resilient repositioning force against the tooth or teeth to be repositioned.

In complex cases, however, many or most of the teeth will be repositioned at some point during the treatment. In such cases, the teeth which are moved can also serve as a base or anchor region for holding the repositioning appliance. Additionally, the gums, palate, opposing arch, and skeletal implants taken alone or in combination can serve as anchor regions, thus allowing all or nearly all of the teeth to be repositioned simultaneously. Usually, no wires or other means will be provided for holding the aligner in place over the teeth. In some cases, however, it will be desirable or necessary to provide individual anchors on teeth with corresponding receptacles or apertures in the aligner 200 so that the aligner 200 can apply an upward force on the tooth which would not be possible in the absence of such an anchor.

The planning and fabrication of such aligners as an exemplary elastic polymeric positioning appliance is described in detail in U.S. Pat. No. 5,975,893, and in published PCT application WO 98/58596 which designates the United States and which is assigned to the assignee of the present application.

Systems of preformed aligners employing technology described in U.S. Pat. No. 5,975,893, are commercially available from Align Technology, Inc., Santa Clara, Calif., under the tradename, Invisalign System. Align Technology, Inc., is the assignee of the present application. The Invisalign System relies on designing and fabricating the aligners to be worn by the patient throughout treatment. The design of the aligners relies on computer modeling of a series of successive tooth arrangements, and the individual aligners are designed to be worn over the teeth and to reposition the teeth to each of the tooth arrangements. Usually, the set of aligners which is designed and fabricated at the outset of the treatment is able to successfully reposition the teeth to a final desired arrangement.

In embodiments of the present invention, the aligners may be planned and all individual aligners fabricated at the outset of treatment. As such, the aligners may thus be provided to the patient as a single package or system. The order in which the aligners are to be used will be clearly marked, (e.g. by sequential numbering) so that the patient can place the aligners over his or her teeth at a frequency prescribed by the orthodontist or other treating professional. Unlike braces, the patient need not visit the treating professional every time an adjustment in the treatment is made. While patients will usually want to visit their treating professionals periodically to assure that treatment is going according to the original plan, eliminating the need to visit the treating professional each time an adjustment is to be made allows the treatment to be carried out in many more, but smaller, successive steps while still reducing the time spent by the treating professional with the individual patient. Moreover, the ability to use polymeric shell appliances which are more comfortable, less visible, and removable by the patient, greatly improves patient compliance, comfort, and satisfaction.

### Thin Film for Improving Dental Esthetics

Throughout the body of this Specification, the use of the terms “aligner” or “dental aligner” is synonymous with the use of the terms “appliance” and “dental appliance” in terms of dental applications. For purposes of clarity, embodiments of the present invention are hereinafter described within the context of the use and application of dental appliances, and more specifically “polymeric shell dental appliances,” or “dental appliances.”

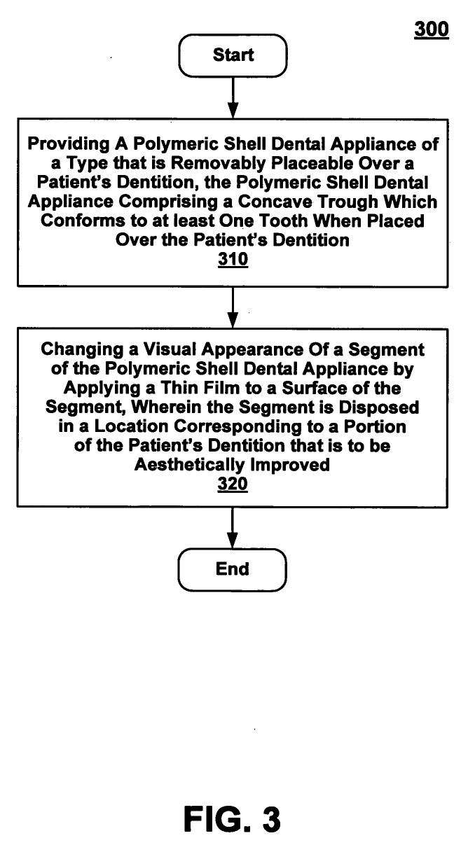

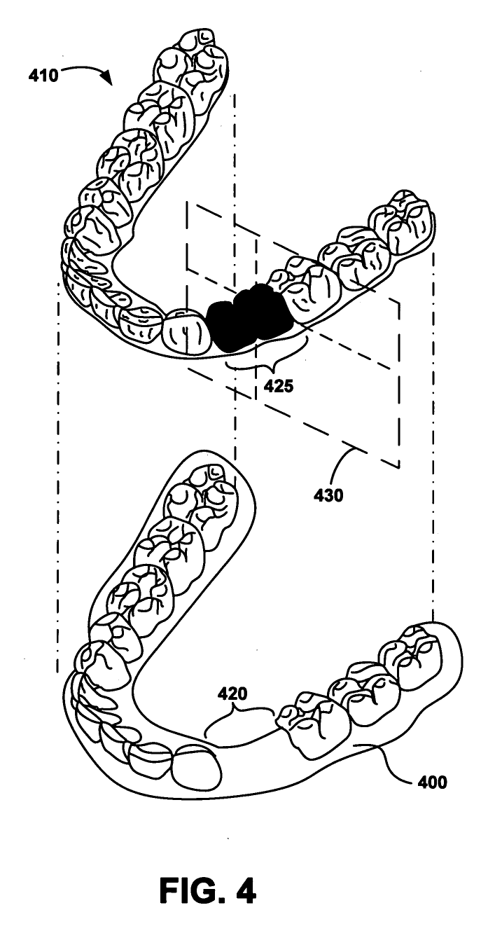

FIGS. 3 and 4 in combination illustrate a method for improving dental esthetics using polymeric shell dental appliances that have been cosmetically altered, in accordance with embodiments of the present invention. FIG. 3 illustrates the method for improving dental esthetics, and FIG. 4 is an application of the method of FIG. 3.

Referring now to FIG. 3, a flow chart 300 is shown illustrating steps in a method for improving a dental esthetics of a patient's dentition, in accordance with one embodiment of the present invention. For example, embodiments of the present invention are used to improve the appearance of abnormalities within a patient's dentition (e.g., missing teeth) when wearing a polymeric shell dental appliance.

At 310, the present embodiment provides a polymeric shell dental appliance. In particular, the dental appliance is of a type that is removably placeable over a patient's dentition. That is, the polymeric shell dental appliance comprises a concave trough which conforms to at least one tooth when placed over the patient's dentition.

FIG. 4 is an exemplary diagram showing a single adjustment polymeric shell dental appliance 410 which is worn by the patient to achieve an incremental repositioning of individual teeth of a lower jaw 400, in accordance with one embodiment of the present invention. Dental appliance 410 is one of a series of incremental position adjustment appliances worn by the patient to realign teeth from an initial tooth arrangement to a final tooth arrangement. As shown, dental appliance 410 comprises a concave shaped cavity shaped preferably, but not necessarily, to fit over all teeth present in lower jaw 400. For example, polymeric shell dental appliance 410 is analogous to aligner 200 described in relation to FIG. 2B. As such, a full discussion of the use and application of polymeric shell dental appliance 410 is provided in relation to the discussion of aligner 200 of FIG. 2B.

Returning to FIG. 3, at 320, the present embodiment changes a visual appearance of the polymeric shell dental appliance. Specifically, a segment of the dental appliance is cosmetically altered by applying a thin film to a surface of the segment. The segment is disposed in a location of the polymeric shell dental appliance that corresponds to a portion of the patient's dentition that is to be esthetically improved. For instance, embodiments of the present invention are used to esthetically improve the appearance of a gap between teeth, discoloration and deterioration of teeth, a mismatch between the polymeric shell dental appliance and one or more teeth, etc.

Determining the location of segment is achieved through various techniques, in accordance with embodiments of the present invention. In one embodiment, a dental professional performs the process used to define the dimensions of the segment within the polymeric shell dental appliance. Specifically, the dental professional is able to define the portion of the patient's dentition which is identified to be esthetically improved. For example, parameters (e.g., width, height, size) are used to define the portion of the patient's dentition marked for esthetic improvement. In one embodiment, the portion is defined within the context of the various digital data sets (IDDS, INTDDS, and FDDS) used to define the alignment of the patient's teeth during the stages of repositioning of the teeth. As such, the identified portion of the patient's dentition marked for esthetic improvement is matched to a corresponding location in the polymeric shell dental appliance used for a particular stage. In one embodiment, these parameters are included in the various digital data sets so that the manufacturer of the polymeric dental application is able to identify the location of the segment in order to cosmetically alter the segment to esthetically improve the patient's dentition when wearing the polymeric shell dental appliance, as will be described below.

In the example provided in FIG. 4, a gap 420 is present between teeth of lower jaw 400. In particular, two teeth are missing from lower jaw 400 in gap 420. If uncorrected, gap 420 is visible from an anterior view of the patient's teeth with or without wearing of a polymeric shell dental appliance. Embodiments of the present invention are capable of improving the appearance of gap 420 when wearing polymeric shell dental appliance 410.

As shown in FIG. 4, a segment 425 of polymeric shell dental appliance 410 is cosmetically altered to improve the dental esthetics of a patient. The location of the segment in dental appliance 410 is determined to correspond to a portion of the patient's dentition that is to be esthetically improved. Specifically, in the example of FIG. 4 the location of segment 425 corresponds to a gap 420 between teeth of the patient's dentition. That is, segment 425 corresponds to gap 420 in lower jaw 400 when polymeric shell dental appliance 410 is worn by the patient.

In accordance with one embodiment, segment 425 is cosmetically altered through the application of a thin film to a surface of segment 425. For ease of illustration, the presence of the thin film is shown by coloring segment 425 black. In actual practice, of course, the appearance of the thin film will usually be colored a shade of white to match the patient's other teeth, in accordance with one embodiment of the present invention. As such, when polymeric shell dental appliance 410 is worn by the patient, improvement of the dental esthetics of gap 420 is achieved, since the thin film in segment 425 gives the appearance of the presence of teeth in gap 420.

Although the present embodiment of FIG. 4 illustrates the improvement of the dental esthetics of a patient's dentition when a gap in the patient's dentition is present, other embodiments of the present invention are well suited to improving dental esthetics of a portion of a patient's dentition under varying conditions. For instance, in one embodiment, dental esthetics is improved in a location of segment 425 that corresponds to a tooth in the patient's detention. For example, the tooth may be discolored through decay, or other natural causes. In another embodiment, the dental esthetics is improved in a location of segment 425 that corresponds to a mismatch between polymeric shell dental appliance 410 and the patient's teeth.

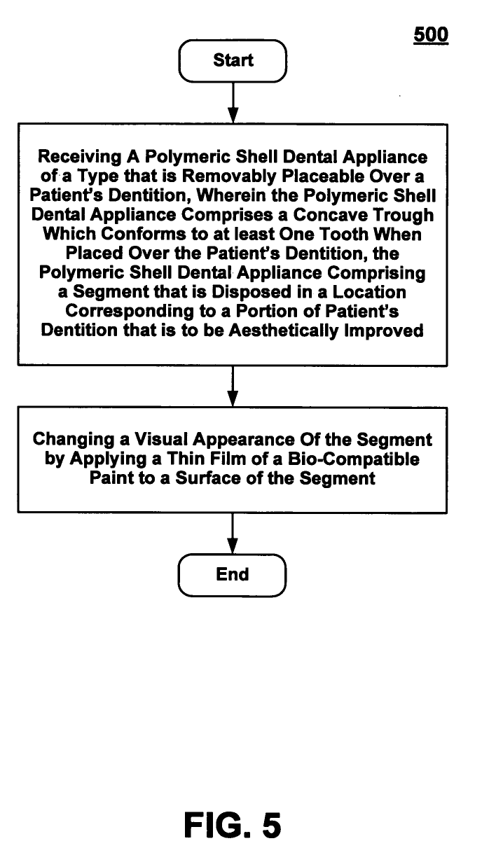

FIG. 5 is a flow chart 500 illustrating steps in a method for improving dental esthetics of a patient's dentition, in accordance with one embodiment of the present invention. For purposes of illustration, FIG. 5 is also described in conjunction with FIG. 4 to illustrate the application of the method of flow chart 500 on polymeric shell dental appliance 410.

At 510, the present embodiment receives a polymeric shell dental appliance. The dental appliance is worn by the patient to achieve an incremental repositioning of individual teeth of a lower or upper jaw. For example, the polymeric shell dental appliance is analogous to dental appliance 200 of FIG. 2B, and dental appliance 410 of FIG. 4.

More specifically, the dental appliance is of a type that is removably placeable over a patient's dentition. In particular, the polymeric shell dental appliance comprises a concave trough which conforms to at least one tooth when placed over the patient's dentition. In the example of FIG. 4, dental appliance 410 comprises a concave shaped cavity shaped preferably, but not necessarily, to fit over teeth present in lower jaw 400. A full discussion of polymeric shell dental appliances is provided in relation to the discussion of aligner 200 of FIG. 2B, and of dental appliance 410 of FIG. 4.

Additionally, polymeric shell dental appliance 410 comprises a segment that is disposed in a location corresponding to a portion of a patient's dentition that is to be esthetically improved. In the example of FIG. 4, the location of segment 425 corresponds to gap 420 in lower jaw 400 when polymeric shell dental appliance 410 is worn by the patient. Other embodiments are well suited to improving dental esthetics of discoloration and deterioration of teeth, mismatches between the polymeric shell dental appliance and one or more teeth, etc.

Determining the location of segment 425 is achieved through various techniques, in accordance with embodiments of the present invention. As described previously, in one embodiment, a dental professional is able to define the dimensions of the segment within the polymeric shell dental appliance. These dimensions (e.g., parameters) are then used to identify, or mark the location of the segment in the dental appliance. As such, the segment can then be cosmetically altered to esthetically improve the patient's dentition when wearing the polymeric shell dental appliance, as will be described more fully in relation to 520.

In accordance with another embodiment of the present invention, the location of segment in the polymeric shell dental appliance is determined through visual identification and measurement. That is, in this embodiment, the location is determined without performing the more complex procedures used by a dental professional to define the parameters of the location in relation to the digital data sets, as described in a previous embodiment. For example, in one embodiment, the location of the segment is identified by wearing the dental appliance and marking the location, or combinations thereof, not necessarily in that particular order. That is, the dental appliance can be worn to determine visually if the location of the segment corresponds to the portion of the patient's dentition identified for esthetic improvement. Further iterations of these two operations are implemented to precisely identify the location of the segment in the dental appliance.

As such, in the present embodiment of visual identification and measurement, the location of the segment can be determined by a dental professional without employing the more complex procedures used to define the parameters of the location in relation to the digital data sets, as described in the embodiment above. Moreover, the present embodiment can be implemented by someone other than the dental professional, such as the patient, or any other person. In addition, the present embodiment can be implemented outside of the confines of a dental establishment (e.g., within the patient's home, etc.). In these embodiments, the involvement of the dental professional is greatly reduced, which correspondingly reduces the cost of supplying polymeric shell dental appliances that are capable of improving dental esthetics.

In the present embodiment of visual identification and measurement, the location of the segment may not correspond precisely with the portion of the patient's dentition that is identified for esthetic improvement. However, embodiments of the present invention are capable of providing for improvement of dental esthetics of a portion of a patient's dentition even though imprecise measurements of the segment are used. For example, even if the location of the segment overlaps into neighboring teeth, the polymeric dental appliance can still be worn after cosmetically altering the segment since the cosmetically alterations minimally interact with the patient's teeth. The present embodiment is distinguished from the conventional art of using pontics to fill a gap which needs precise measurements of the pontic when integrated with the dental appliance. For example, if the pontic overlaps with the neighboring teeth, the dental appliance will not fit over the teeth when the dental appliance is worn. However, in embodiments of the present invention even if the cosmetically altered segment overlaps the neighboring teeth, the dental appliance can still be worn over the teeth. Additionally, the overlap may not be noticeable, especially if the cosmetic alterations are made to simulate the color of the neighboring teeth.

At 520, the present embodiment changes a visual appearance of the segment of the polymeric shell dental appliance. Specifically, the segment of the dental appliance is cosmetically altered by applying a thin film to a surface of the segment. The segment is disposed in a location of the dental appliance that substantially corresponds to a portion of the patient's dentition that is to be esthetically improved, as previously described.

In one embodiment, the visual appearance is changed by applying a thin film of water-insoluble paint to a surface of the segment. Specifically, the paint is bio-compatible in order to be safely used within an oral environment. That is, the bio-compatible paint is not harmful when the patient wears the polymeric shell dental appliance that has been cosmetically altered through the application of the bio-compatible paint to the segment of the dental appliance.

In one embodiment, a bonding agent is integrated within the bio-compatible paint. As such, the bio-compatible paint can more easily bond to the thermoplastic of the polymeric shell dental appliance. In one embodiment, the bonding agent comprises a solvent. The solvent is capable of evaporating quickly for fast drying. More specifically, the bio-compatible paint will bond to the surface of the segment of the polymeric dental appliance. In this case, the integrity of the bonding of the bio-compatible paint to the dental appliance is excellent. Namely, the integrity of the application of bio-compatible paint to the dental appliance is not compromised even when subjected to torsional or flexing forces, such as when the dental appliance is either being inserted or removed from a patient's mouth, or when vigorously cleaning the dental appliance.

In another embodiment, the visual appearance is changed by applying a bio-compatible and substantially water-resistant adhesive to the surface of the segment. Thereafter, a thin foil is applied to the adhesive, wherein the thin film comprises the thin foil. In still other embodiments, the thin film and the adhesive are combined, trimmed to fit the segment, and applied to the segment.

In one embodiment, the thin film (e.g., bio-compatible paint or thin foil) is configured to create the appearance of a tooth in the polymeric shell dental appliance. For instance, the thin film is configured to match a desired tooth shade of neighboring teeth of a patient. For example, the desired tooth shade can be any shade of white, yellow, brown, gray, or any other tooth color. In another embodiment, the thin film is configured to create the appearance of a metal crown inside the polymeric shell dental appliance.

In still another embodiment, the thin film is used purely for decorative purposes. That is, the thin film can be any colored material for creating a colored image that is integrated with the polymeric shell dental appliance. For instance, the colored material may be black, or red, bright neon, metallic coloring, any other color, or any type of image.

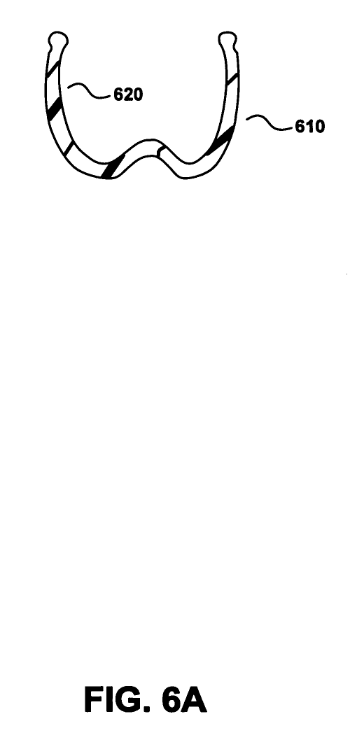

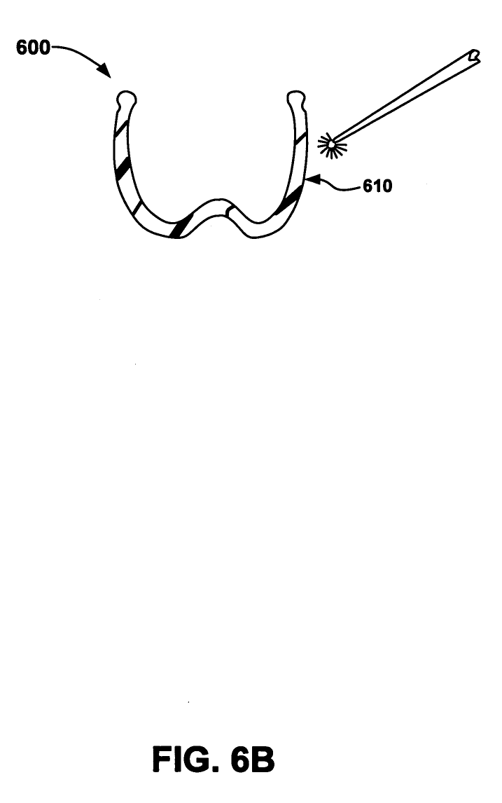

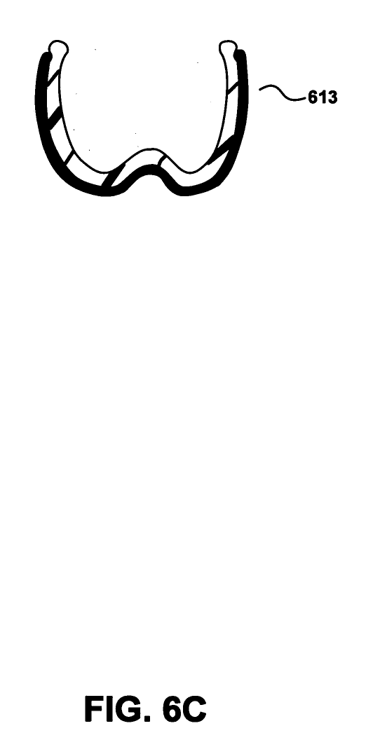

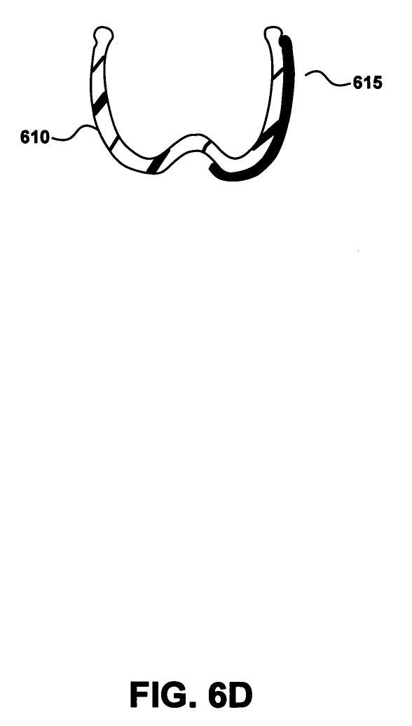

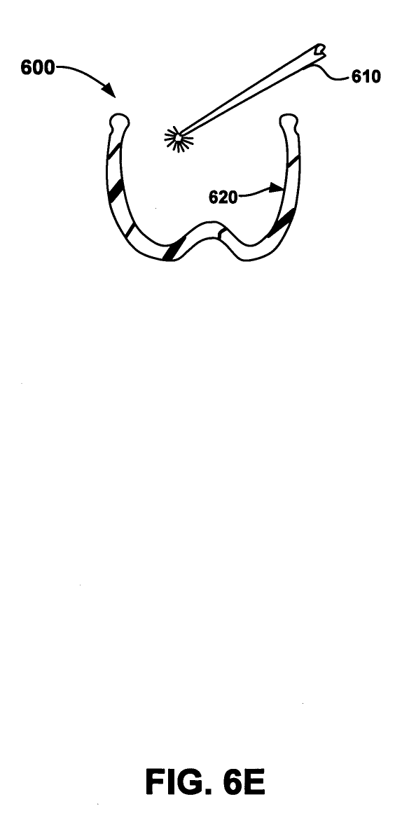

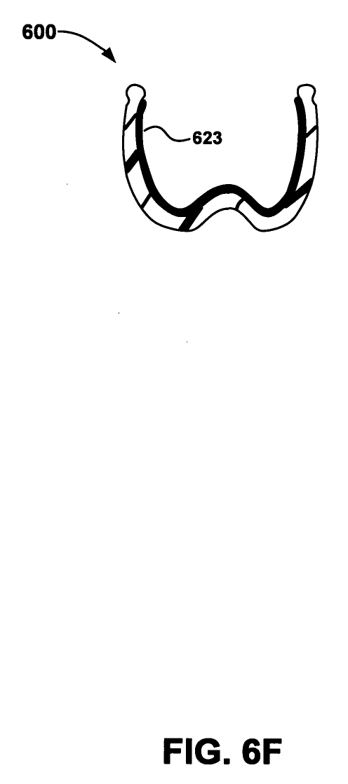

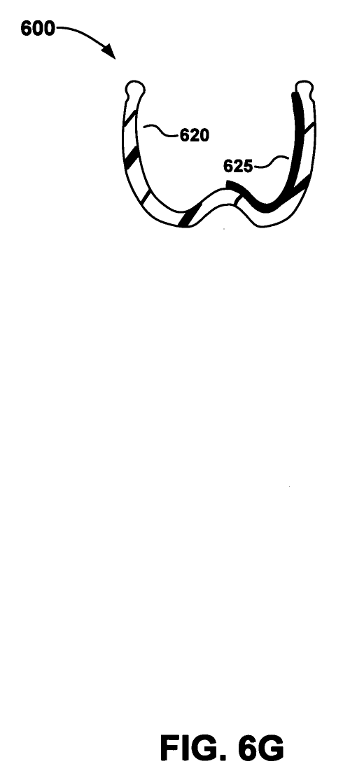

FIGS. 6A-6G provide cross sectional views of polymeric shell polymeric shell dental appliance 410 of FIG. 4 in a location which corresponds to a portion of the patient's dentition that is to be esthetically improved, in accordance with embodiments of the present invention. Specifically, FIGS. 6A-6G provide a cross-section 600 of dental appliance 410 that is taken along plane 430. As shown in FIG. 4, plane 430 provides a cross section 600 of a cavity in the trough of the polymeric shell dental appliance 410. In particular, cross section 600 is located in segment 425 that corresponds to gap 420 in lower jaw 400 that is identified for improving its dental esthetics.

Now referring to FIG. 6A, cross-section 600 of polymeric shell dental appliance 410 is shown, in accordance with one embodiment of the present invention. Specifically, cross-section 600 comprises an interior surface 620. Interior surface 620 is adjacent the teeth when polymeric shell dental appliance 410 is worn by the patient. In addition, cross-section 600 comprises an exterior surface 610. Exterior surface 610 is not adjacent to the teeth when polymeric shell dental appliance 410 is worn by the patient. That is, exterior surface 610 is more exposed than interior surface 620 to the oral environment of the patient's mouth.

Referring to FIG. 6B, cross-section 600 of polymeric shell dental appliance 410 is shown upon which the thin film is applied, in accordance with one embodiment of the present invention. Specifically, the thin film is applied to an exterior surface 610 of segment 425. The exterior surface is visible when placed over the patient's dentition. That is, dental appliance 410 is substantially transparent. As such, the thin film applied to the exterior surface is also visible.

FIG. 6C shows thin film 613 that is applied to entire exterior surface 610 of the dental appliance, in accordance with one embodiment of the present invention. As such, the entire exterior surface 610 of segment 425 would be covered with thin film 613.

In another embodiment, the thin film is applied to sub-parts of the exterior surface of segment 425. That is, the thin film is applied to some areas of exterior surface 610 of segment 425. For example, in FIG. 6D, thin film 615 is applied to approximately the right half of exterior surface 610.

Now referring to FIG. 6E, cross-section 600 is shown upon which the thin film is applied by applicator 610, in accordance with one embodiment of the present invention. Specifically, the thin film is applied to an interior surface 620 of segment 425. The interior surface is visible when placed over the patient's dentition. That is, dental appliance 410 is substantially transparent. As such, the thin film applied to the interior surface is also visible.

FIG. 6F shows thin film 623 that is applied to the entire interior surface of the dental appliance, in accordance with one embodiment of the present invention. As such, the entire interior surface 620 of segment 425 would be covered with thin film 623.

In another embodiment, the thin film is applied to sub-parts of the interior surface 620 of segment 425. That is, the thin film is applied to some areas of the interior surface 620 of segment 425. For example, in FIG. 6G, thin film 625 is applied to approximately the right half of interior surface 620.

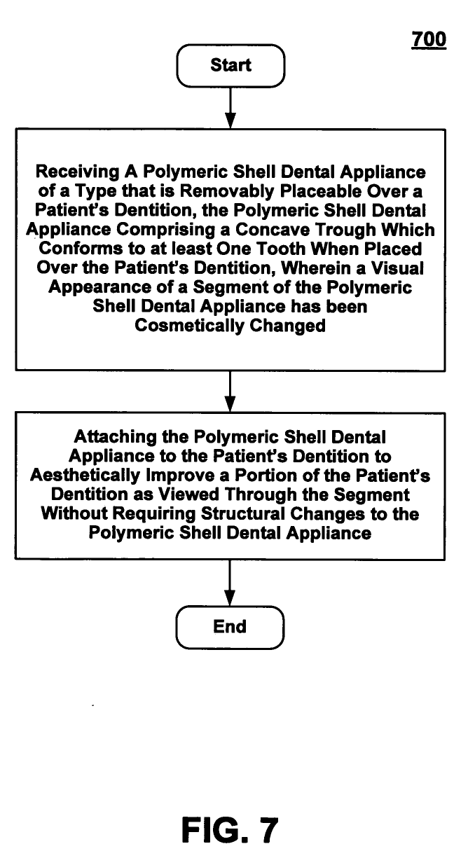

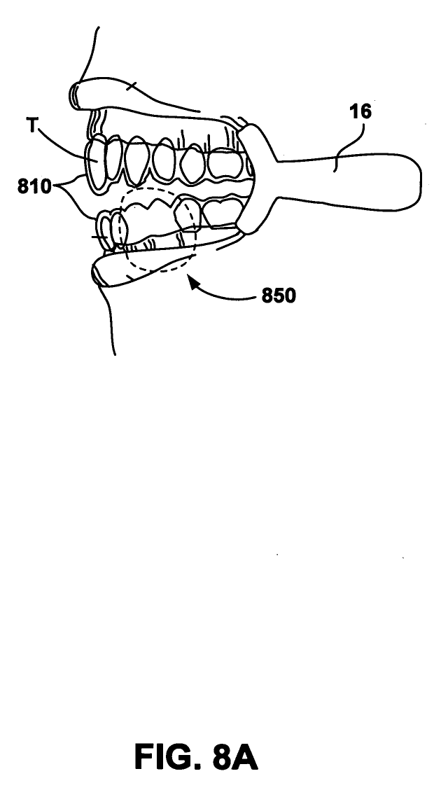

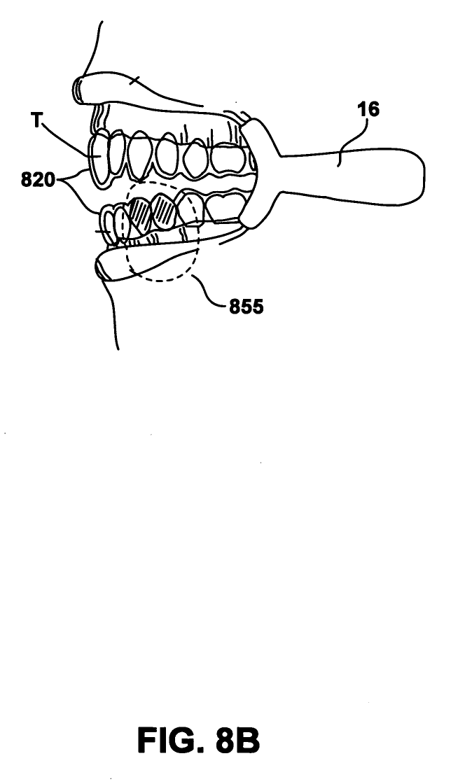

FIGS. 7, 8A, and 8B in combination illustrate a method for improving dental esthetics using polymeric shell dental appliances that have been cosmetically altered, in accordance with embodiments of the present invention. FIG. 7 illustrates the method for improving dental esthetics, and FIGS. 8A and 8B are applications of the method of FIG. 7.

FIG. 7 is a flow chart illustrating steps in a method for esthetically improving a patient's dentition through the attaching of a polymeric shell dental appliance that has been cosmetically changed, in accordance with one embodiment of the present invention.

At 710, the present embodiment receives a polymeric shell dental appliance. The dental appliance is worn by the patient to achieve an incremental repositioning of individual teeth of a lower or upper jaw. For example, the polymeric shell dental appliance is analogous to dental appliance 200 of FIG. 2B, and dental appliance 410 of FIG. 4. A full discussion of polymeric shell dental appliances is provided in relation to the discussion of aligner 200 of FIG. 2B, and of dental appliance 410 of FIG. 4.

More specifically, the dental appliance is of a type that is removably placeable over a patient's dentition. In particular, the polymeric shell dental appliance comprises a concave trough which conforms to at least one tooth when placed over the patient's dentition. As an example, as shown in FIG. 4, dental appliance 410 comprises a concave shaped cavity shaped preferably, but not necessarily, to fit over teeth present in the patient's mouth.

Additionally, the polymeric shell dental appliance comprises a segment that is disposed in a location corresponding to a portion of a patient's dentition that is to be esthetically improved, as described previously. More particularly, a visual appearance of the segment has been cosmetically changed. For example, a thin film has been applied to a surface of the segment, as previously described in relation to FIGS. 4 and 6A-6G. In one embodiment, the thin film comprises a bio-compatible paint. In another embodiment, the thin film comprises a thin foil and an water resistant adhesive used to attach the thin foil to the surface of the segment.

At 720, the present embodiment attaches the polymeric shell dental appliance to the patient's dentition to esthetically improve the patient's dentition. In particular, a portion of the patient's dentition is improved as viewed through the segment of the dental appliance, without requiring structural changes to the dental appliance. In particular, the present embodiment is capable of esthetically improving the patient's dentition without requiring a formation of a pontic in a cavity of the polymeric shell dental application, wherein the cavity corresponds to a location of the segment.

In particular, FIG. 8A is a diagram illustrating the placement of a polymeric shell dental appliance 810 over a patient's teeth T without any improvement in dental esthetics, in accordance with one embodiment of the present invention. Retractor 16 is used to further expose the patient's teeth T. Focusing on isolation area 850, a gap in teeth T of the lower jaw is visible through dental appliance 810. In this case, dental appliance 810 has not been cosmetically changed.

On the other hand, FIG. 8B is a diagram illustrating the placement of a polymeric shell dental appliance 820 over a patient's teeth T for purposes of improving dental esthetics of patient's teeth T, in accordance with one embodiment of the present invention. Retractor 16 is used to further expose patient's teeth T. The patient's teeth T are identical to the teeth shown in FIG. 8A, and as such would necessarily have a gap between teeth in the lower jaw.

Focusing on isolation area 855 in FIG. 8B, dental appliance 820 has been cosmetically altered by applying a thin film to a surface of a segment of dental appliance 820. The segment corresponds to a portion of the patient's dentition that is identified for improving dental esthetics (e.g., the gap that is present in FIG. 8A). Without the thin film, the gap in teeth T would be readily visible, as in FIG. 8A. On the other hand, the thin film gives the appearance that teeth are present in isolation area 855. For ease of illustration, the presence of the thin film in FIG. 8B is shown by the hash marks on polymeric dental appliance 820 in the isolation area 855. In actual practice, of course, the appearance of the thin film will usually be colored a shade of white to match the patient's other teeth, in accordance with one embodiment of the present invention. As such, when polymeric shell dental appliance 820 is worn by the patient, improvement of the dental esthetics of the gap in teeth T is achieved, since the thin film gives the appearance of the presence of teeth in the dental appliance in isolation area 855.

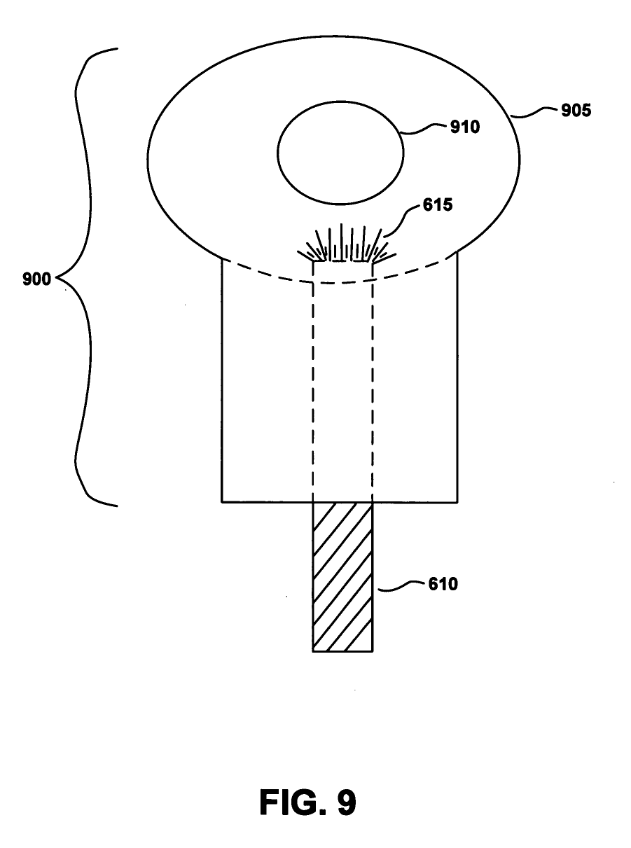

FIG. 9 is a diagram of a container 900 used for improving dental esthetics, in accordance with one embodiment of the present invention. In the present embodiment, container 900 is also used in a method for packaging a system for improving dental esthetics.

As shown in FIG. 9, a bio-compatible paint is provided in container 900. In the present embodiment, container 900 comprises a single-dose of bio-compatible paint used for applying to a polymeric shell dental appliance. That is, container 900 and the bio-compatible paint contained therein is intended to be used once. For instance, the bio-compatible paint is shaded a tooth color, or may be used for decorative purposes to change the appearance of a patient's dentition, as previously described. In the single-dose embodiment, the bio-compatible paint can be dispensed by the dental professional, a third party, or the patient.

In one embodiment, the bio-compatible paint is sealed in container 900. For example, the bio-compatible paint is sealed within sealed compartment 910. In this case, the bio-compatible paint remains sterile until use. As such, use of bio-compatible paint in single-dose container 900 is sanitary. Also, the risk of solvent evaporation over time is reduced since the bio-compatible paint is intended for immediate use.

In another embodiment, container 900 comprises multiple-doses of bio-compatible paint. That is the bio-compatible paint in container 900 can be used for applying to multiple polymeric shell dental appliances. For example, container 900 may be a bottle.

In the embodiment of FIG. 9, container 900 is breakable to gain access to the bio-compatible paint. In particular, as shown in FIG. 9, sealed compartment 910 is breakable. For example, an actuator can be used to break or pierce the seal on compartment 910 to gain access to the bio-compatible paint.

Thereafter, the applicator brush 610 is used to apply the bio-compatible paint to the polymeric shell dental appliance. That is, the tip 615 of applicator brush 610 is used to soak in the bio-compatible paint. Brush tip 615 is also used to apply the bio-compatible paint to a surface of a segment of the dental appliance, wherein the segment is intended for cosmetic change. That is, the segment when worn by a patient is disposed in a location corresponding to a portion of a patient's dentition that is to be esthetically improved.

In one embodiment, container 900 and applicator brush 610 are enclosed in a sterile compartment 905. As shown, bio-compatible paint and brush tip 615 are enclosed in the sterile package. In another embodiment, container 900 and applicator brush 610 are completely enclosed in a sterile package. As such, a single-dose container can be effectively be used by either the dental professional in the dental establishment, a third party outside of the dental establishment, or by a patient at home without risk of introducing harmful contaminants into the bio-compatible paint prior to use.

In still another embodiment, the bio-compatible paint comprises a solid powder. Mixing the solid paint powder with a solvent activates the solvent to provide additional characteristics to the bio-compatible paint. For instance, the bio-compatible paint transitions to a form that is suitable for application to the polymeric shell dental appliance, in one embodiment. Also, in another embodiment, the reaction of components in the solvent and solid paint powder provides additional film strength characteristics for the bio-compatible paint.

In one embodiment, the bio-compatible paint in powder form is separated from the solvent until the bio-compatible paint is ready for application to the polymeric shell dental appliance. In one embodiment, the bio-compatible paint in powder form is preloaded on applicator brush 610. The solvent is contained within a separate, sealed compartment that is accessible at the appropriate time. For example, the solvent could be included in sealed compartment 910 that is breakable to allow for mixing of the solid paint powder on the applicator brush 610 and the solvent. In another embodiment, the solid paint powder and the solvent are each contained within a separate, sealed compartment. Each of the sealed compartments is breakable to allow for access to the contents stored within. As such, the solid paint powder and the solvent can be accessed and mixed together for application of the bio-compatible paint to the polymeric shell dental appliance.

Accordingly, various embodiments of the present invention disclose the application of thin films to polymeric shell dental appliances in a location corresponding to a position of a patient's dentition intended for esthetic improvement. As a result, embodiments of the present invention provide the above accomplishment, and further provide for excellent bonding of the thin film to the polymeric shell dental appliance, thereby improving the integrity of the modification to the polymeric shell dental appliance intended to improve dental esthetics of a patient's dentition. Moreover, embodiments of the present invention provide the above accomplishments and further provide for less involvement of a dental professional when providing the improvement of dental esthetics, and therefore a reduction in the overall cost of the use of polymeric shell dental appliances.

While the methods of embodiments illustrated in flow charts 300, 500, and 700 show specific sequences and quantity of steps, the present invention is suitable to alternative embodiments. For example, not all the steps provided for in the method are required for the present invention. Furthermore, additional steps can be added to the steps presented in the present embodiment. Likewise, the sequences of steps can be modified depending upon the application.

Embodiments of the present invention, methods and system for applying thin films to polymeric shell dental appliances for improving dental esthetics have been described. While the invention is described in conjunction with the preferred embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

What is claimed:

1. A method for improving dental esthetics, comprising:
providing a polymeric shell dental appliance of a type that is removably placeable over a patient's dentition, said polymeric shell dental appliance comprising a concave trough which conforms to at least one tooth when placed over said patient's dentition; and
changing a visual appearance of a segment of said polymeric shell dental appliance by applying a thin film to a surface of said segment, wherein said segment is disposed in a location corresponding to a portion of said patient's dentition that is to be esthetically improved.

2. The method of claim 1, wherein said changing a visual appearance comprises:
applying a bio-compatible paint as said thin film to said surface of said segment.

3. The method of claim 1, wherein said changing a visual appearance comprises:
applying a bio-compatible adhesive to said surface of said segment; and
applying a thin foil as said thin film to said adhesive.

4. The method of claim 1, further comprising:
determining said location of said segment corresponding to said portion of said patient's dentition that comprises a gap between teeth of said patient's dentition.

5. The method of claim 1, further comprising:
determining said location of said segment corresponding to said portion of said patient's dentition that comprises at least one tooth.

6. The method of claim 1, wherein said changing a visual appearance comprises:
applying said thin film having a desired tooth shade to said surface of said segment.

7. The method of claim 1, wherein said changing a visual appearance comprises:
applying said thin film having a decorative color to said surface of said segment.

8. The method of claim 1, wherein said changing a visual appearance comprises:
applying said thin film to an interior surface of said segment, wherein said interior surface is visible when placed over said patient's dentition.

9. The method of claim 1, wherein said changing a visual appearance comprises:
applying said thin film to an exterior surface of said segment, wherein said exterior surface is visible when placed over said patient's dentition.

10. The method of claim 1, wherein said providing a polymeric shell dental appliance comprises:
generating said polymeric shell dental appliance from computer based modeling of said patient's dentition bringing said patient's detention from an initial digital data set representing an initial tooth arrangement to a final digital data set representing a final tooth arrangement.

11. A method for improving dental esthetics, comprising:
providing a polymeric shell dental appliance of a type that is removably placeable over a patient's dentition, said polymeric shell dental appliance comprising a concave trough which conforms to at least one tooth when placed over said patient's dentition, wherein said polymeric shell dental appliance is generated from computer based modeling of said patient's dentition bringing said patient's detention from an initial digital data set representing an initial tooth arrangement to a final digital data set representing a final tooth arrangement; and
changing a visual appearance of a segment of said polymeric shell dental appliance by applying a thin film to a surface of said segment, wherein said segment is disposed in a location corresponding to a portion of said patient's dentition that is to be esthetically improved.

12. A method for improving dental esthetics, said method comprising:
receiving a polymeric shell dental appliance of a type that is removably placeable over a patient's dentition, wherein said polymeric shell dental appliance comprises a concave trough which conforms to at least one tooth when placed over said patient's dentition, said polymeric shell dental appliance comprising a segment that is disposed in a location corresponding to a portion of a patient's dentition that is to be esthetically improved; and
changing a visual appearance of said segment by applying a thin film of a bio-compatible paint to a surface of said segment.

13. The method of claim 12, wherein said changing a visual appearance comprises:
changing said visual appearance of said segment, wherein said segment corresponds to said portion of said patient's dentition comprising a tooth that is missing.

14. The method of claim 13, further comprising:
selecting a desired tooth shade for said bio-compatible paint.

15. The method of claim 12, further comprising:
integrating a bonding agent to said bio-compatible paint.

16. The method of claim 15, further comprising:
integrating said bonding agent to said bio-compatible paint, wherein said bonding agent comprises a solvent.

17. The method of claim 12, wherein said changing a visual appearance comprises:
applying said thin film to an interior surface of said segment, wherein said interior surface is visible when placed over said patient's dentition.

18. The method of claim 12, wherein said changing a visual appearance comprises:
applying said thin film to an exterior surface of said segment, wherein said exterior surface is visible when placed over said patient's dentition.

19. The method of claim 12, further comprising:
attaching said polymeric shell dental appliance to said patient's dentition to esthetically improve said patient's dentition.

20. A method for applying a dental appliance to improve dental esthetics, comprising:
receiving a polymeric shell dental appliance of a type that is removably placeable over a patient's dentition, said polymeric shell dental appliance comprising a concave trough which conforms to at least one tooth when placed over said patient's dentition, wherein a visual appearance of a segment of said polymeric shell dental appliance has been cosmetically changed; and
attaching said polymeric shell dental appliance to said patient's dentition to esthetically improve a portion of said patient's dentition as viewed through said segment without requiring structural changes to said polymeric shell dental appliance.

21. The method of claim 20, wherein said receiving a polymeric shell dental appliance further comprises:
changing a visual appearance of said segment by applying a thin film to a surface of said segment.

22. The method of claim 21, wherein said changing a visual appearance comprises:
applying a thin film of bio-compatible paint to said surface of said segment.

23. The method of claim 21, wherein said changing a visual appearance comprises:
applying a bio-compatible adhesive to said surface of said segment; and
applying a thin foil comprising said thin film to said bio-compatible adhesive.

24. The method of claim 20, wherein said without requiring structural changes comprises:
without requiring a formation of a pontic in a cavity of said polymeric shell dental appliance that corresponds to a location of said segment.

25. A method for packaging an apparatus used for improving dental esthetics, said method comprising:
providing a bio-compatible paint in a container, wherein said container is breakable to gain access to said bio-compatible paint, wherein said bio-compatible paint is applied in a thin film to a surface of a segment of a dental appliance, wherein said segment is intended for cosmetic change;
providing an applicator brush for applying said bio-compatible paint to said surface of said segment; and
enclosing said container and said applicator brush in a sterile package.

26. The method of claim 25, further comprising:
shading said bio-compatible paint to match a tooth shade.

27. The method of claim 25, further comprising:
shading said bio-compatible paint a decorative color.

28. The method of claim 25, further comprising:
providing a single dose of said bio-compatible paint in said container.

29. The method of claim 25, further comprising:
providing multiple doses of said bio-compatible paint in said container.
